(19) United States
(12) Patent Application Publication
(10) Pub. No.: US 2008/0046937 A1
(43) Pub. Date: Feb. 21, 2008

(54) Playing Content on Multiple Channels of a Media Device

(75) Inventors: LaSean T. Smith, Phoenix, AZ (US); David E. Ulmer, Phoenix, AZ (US)

Correspondence Address: Motorola, Inc.;Law Department, 1303 East Algonquin Road, 3rd Floor, Schaumburg, IL, 60196, US

(73) Assignees: LaSean T. Smith, Phoenix, AZ (US); David E. Ulmer, Phoenix, AZ (US)

(21) Appl. No.: 11/460,526

(22) Filed: Jul. 27, 2006

(51) Int. Cl. H04N 7/16; H04N 7/173

(52) U.S. Cl. 725/89; 725/134; 725/142

(57) ABSTRACT

In a method for playing content on a multi-channel media device, the device receives content, which comprises one of cached and streamed content, and plays the content on a first channel of the multi-channel media device. The multi-channel media device detects a first user-interaction and plays content on a second channel in response to the detected first user-interaction, while simultaneously playing the content on the first channel.

### BACKGROUND

Webcasts have become a popular way of enjoying various forms of media, such as music, television, and movies. Typically, a webcast involves downloading media from a network source, such as the Internet, onto a media device, where a user watches or listens to the media at the user's leisure.

A user of a media device often encounters media they dislike, such as tracks in a music webcast or commercials in a television program. In a standard webcast, changing to the next cached channel to avoid the content the user dislikes would pause the current channel content. Thus, the user would be forced to eventually listen to or watch the content they disliked when the user returned to the channel.

It would therefore be beneficial to users to have the ability to avoid disfavored content while more closely mimicking the behavior of a standard broadcast radio experience.

### SUMMARY

Disclosed is a method for playing content on a multi-channel media device. The method comprises receiving content on at least one channel of a multi-channel media device and playing the content on a first channel of the multi-channel media device, where the content comprises one of cached and streamed content. The method further comprises detecting a first user-interaction with the multi-channel media device and playing content on a second channel of the multi-channel media device in response to detecting the first user-interaction, while simultaneously playing the content on the first channel.

Also disclosed herein is a multi-channel media device for simultaneously playing content on multiple channels. The multi-channel media device includes software configured to decode a first content playable on a first channel of the multi-channel media device, wherein the content comprises at least one of cached and streamed content. The multi-channel media device also includes software configured to decode a second content playable on a second channel of the multi-channel media device. The multi-channel media device further includes a processor configured to implement software for simultaneously playing the decoded second content on the second channel while playing the decoded first content on the first channel.

Further disclosed herein is a computer readable medium upon which is stored a computer program. The computer program implements a method for playing content on a multi-channel media device when executed by a processor. The computer program includes a set of instructions to: receive content on at least one channel of a multi-channel media device; play the content on a first channel of the multi-channel media device, wherein the content comprises one of cached and streamed content; detect a first user-interaction with the multi-channel media device; and play content on a second channel of the multi-channel media device in response to the first user-interaction being detected, while simultaneously playing the content on the first channel.

Through implementation of the systems and methods described herein, a user may avoid listening to and/or viewing disfavored content by changing to another channel while the undesirable content continues to play in the background. As such, skipping content is not required to avoid listening to and/or viewing undesired content. In addition, the systems and methods described herein provide users with greater control of their media experience by allowing them to switch to other content channels while content continues to play in the previously selected channel(s). In one regard, therefore, a user may operate a multi-channel media device in manners that substantially mimic the behavior of standard broadcast radio devices.

### BRIEF DESCRIPTION OF THE DRAWINGS

Embodiments are illustrated by way of example and not limited in the following figure(s), in which like numerals indicate like elements, in which:

FIG. 1 illustrates a flow chart of a method for playing content on a multi-channel media device, according to an embodiment of the invention;

FIG. 2A illustrates a flow chart of a method for operating the media device discussed in FIG. 1, according to embodiment of the invention;

FIG. 2B illustrates a flow chart of a method for operating the media device discussed in FIG. 1, according to another embodiment of the invention;

FIG. 3 illustrates a multi-channel media device that may be used to perform various functions described herein, according to an embodiment of the invention; and

FIG. 4 illustrates a logical flow diagram of a processor configured to perform various functions of the multi-channel media device depicted in FIG. 3, according to an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Disclosed is a multi-channel media device and a method for playing content on a multi-channel media device. The method includes downloading content from a network to a multi-channel media device and playing the content on a first channel of the multi-channel media device. The method allows the user to change the channel on the multi-channel media device to begin playing content on a second channel of the multi-channel media device. However, instead of pausing or stopping the play of the content on the first channel, the first channel continues to play the content, while the second channel is simultaneously playing other content.

The content on the first channel may, for instance, play at a reduced level, such as a lower volume, including an inaudible level, and may stop when the content reaches a stop point. The user may then switch back to the first channel and resume playing the content on the first channel from the stop point. Thus, the method disclosed herein allows a user to avoid having to engage content that the user dislikes, without skipping the content. In addition, the method disclosed herein allows a user to operate a multi-channel media player in manners that closely mimic the behavior of a standard broadcast radio experience.

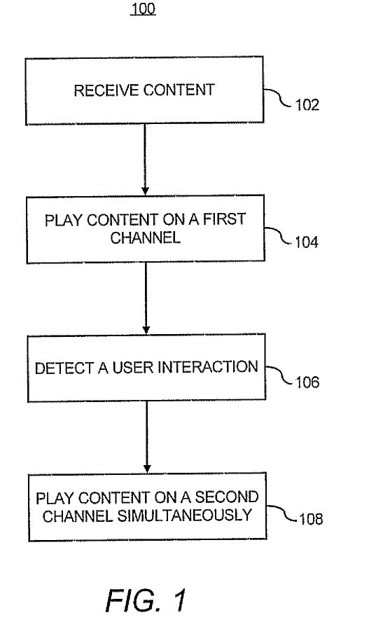

FIG. 1 illustrates a flow chart of a method 100 according to an example. It is to be understood that the following description of the method 100 is but one manner of a variety of different manners in which an example of the invention may be practiced. It should also be apparent to those of ordinary skill in the art that the method 100 represents a generalized illustration and that other steps may be added or existing steps may be removed, modified or rearranged without departing from a scope of the method 100.

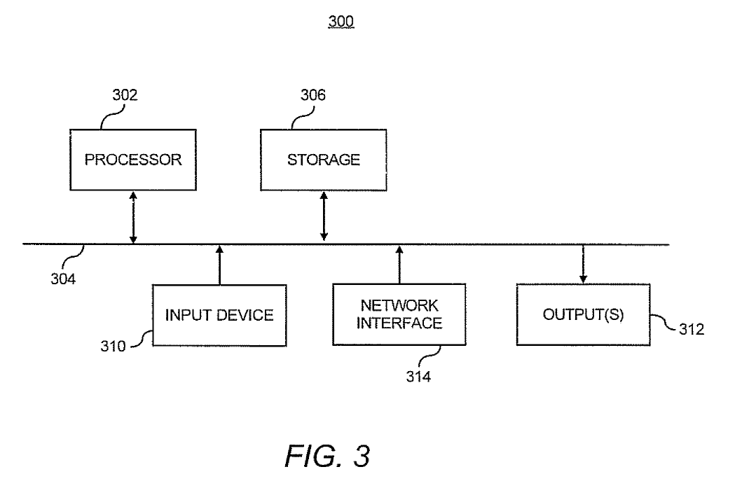

At step 102, the multi-channel media device receives content, such as, cached and streamed content. The multi-channel media device refers to any reasonably suitable device having the capability to receive and play content, such as the multi-channel media device 300 depicted in FIG. 3. Examples of suitable multi-channel media devices include, but are not limited to, personal computers, personal digital assistants, cellular telephones, car radios, home stereos, set-top boxes, MP3 players, portable video players, and other end-user devices. The method 100 may also be used with a webcast player sold under the trade of the IRADIO application, which is available from Motorola, Inc., of Schaumberg, Ill.

The method 100 may be employed in media devices having multiple channels, where a user may switch between different channels to consume different content. For example, one channel may offer a particular music format, such as rock, while another channel may offer a different music format, such as pop. The content may be downloaded from any source, such as the internet or any reasonably suitable local network. The network may include one or more of private networks, public networks, such as the Internet, wireless networks, such as satellite and cellular networks, and local area wireless networks, such as WiFi or Bluetooth networks, wired networks, local area networks, wide area networks, and any other type of communication network.

The content may include: media, such as, audio, video, text; multimedia that includes two or more of audio, video and text; or other types of data. Examples of content include, but are not limited to, media files, such as MP3 files, other types of audio files, video files, textual music play lists, streaming media files, and other types of files. For example, the content may include a song, a series of songs, talk radio formats, books on tape, television programs, and movies. The content may be downloaded onto the media device as streaming data, downloaded in segments or packets, or downloaded in its entirety as an album, show, movie, etc, from one or more content providers.

Examples of content providers may include, but are not limited to, news providers (such as local and cable news television stations), television studios, movie studios, music labels, online music (or other media) providers, and others. In addition, the content may comprise content that is subject to one or more constraints that limit manners in which the content is at least one of received and played.

At step 104, the content is played on a first channel of the multi-channel media device. The content played on the first channel may comprise streaming content or cached content. In addition, the cached content may comprise streaming content previously downloaded onto the media device. For example, at step 104, cached rock music may be played on the first channel of the multi-channel media device.

At step 106, the multi-channel media device detects a first user-interaction. The first user-interaction may include, for example, a user selecting a second channel of the media device. In this example, a user may encounter a song which they dislike while listening to the first channel playing rock music and, to avoid listening to the disliked song, the user may select, for example, a second channel to play pop music.

At step 108, the multi-channel media device plays content on a second channel of the media device while simultaneously playing the content on the first channel of the media device. In one example, the multi-channel media device may play the content on the first channel at a reduced level. A reduced level may include a level not perceived by the user or a level less prominently perceived by the user. A level not perceived by the user may include a level that the user cannot see or hear. For example, when a user interacts with the multi-channel media device to play content on the second channel, the content on the first channel may play silently in the background or at reduced volume that cannot be heard by the human ear. A level less prominently perceived by the user may include a level that makes it relatively difficult for the user to see or hear the content. For example, the content playing on the first channel may still be audible, but at a lower volume, while the pop music playing on the second channel plays at a louder volume.

In addition, or alternatively, at step 108, the content on the first and second channels may play through different speakers or on different speaker systems. For example, the first channel content may play through a left speaker, while the second channel content may play through a right speaker. The content on the first and second channels may also be output through different devices. For example, content playing on the first channel may be played through a headset, while content playing on the second channel may be played through speakers integral with the multi-channel media device. As another example, the content playing on the first channel may comprise audio and the content playing on the second channel may comprise video. As a yet further example, the media device may include a channel, which may include one of the first and second channels, that displays information pertaining to the content playing on either or both of the first and second channels.

If media having visual data is being played on a first channel of the multi-channel media device, the visual display for the first channel may be dimmed, such that the human eye can no longer see the visual display playing on the first channel. Alternatively, the visual media playing on the first channel may be reduced in size and moved to a less prominent position on the user's viewing screen, such as a “picture-in-picture (PIP)” function.

Although not explicitly shown in FIG. 1, steps 102-108 may be repeated for additional channels. In this regard, for instance, content may simultaneously be played on more than two channels of the multi-channel media device without departing from a scope of the method 100.

The ability to simultaneously play content on multiple channels as indicated at step 108 may be disabled. In addition, or alternatively, the ability to play particular segments of the content concurrently with other content may be disabled. In this regard, a user may, in certain situations, be prevented from having the ability to play the content concurrently with other content as described with respect to step 108.

The ability to simultaneously play the content on the first channel with content on the second channel may be disabled, for instance, by the provider of the content for business or promotional purposes. By way of example, the content provider may wish to include a commercial or a particular promotional segment in a channel that would continue to play if the channel were changed, to thereby enforce the requirement for a user to hear or view the entire desired segment of the content.

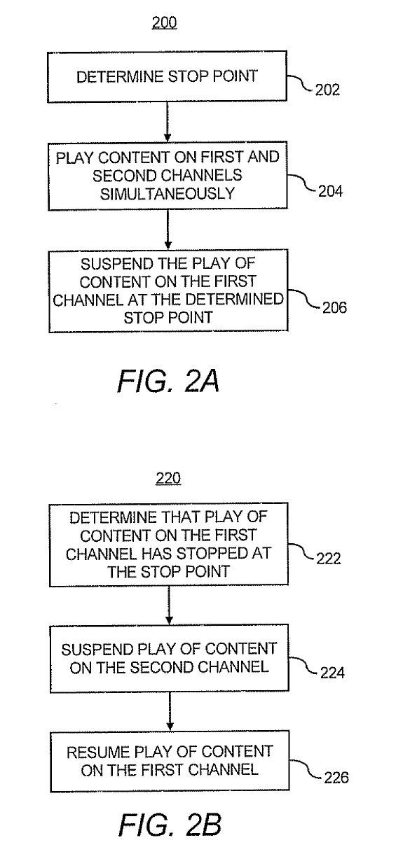

FIG. 2A illustrates a flow chart of a method 200 for operating the media device, according to another example. Generally speaking, the method 200 may be implemented in conjunction with the method 100 depicted in FIG. 1. More particularly, one or more of the steps outlined in the method 200 may be performed before, during, or after the steps outlined in the method 100 as described in greater detail herein below. In addition, the method 200 may be performed to determine and implement a stop point in the playing of the content on the first channel. The method 200 may moreover be implemented to determine and implement stop points in the playing of content on one or more channels in addition to the first channel. This situation may arise, for instance, when more than two channels are concurrently playing content.

At step 202, a stop point may be determined. For instance, a stop point may be set by a content provider or distributor or a stop point may be a natural point in the content. A natural point may be any reasonably suitable point inherently present in the content due to the nature of the content. For example, a natural stop point in musical content may be the end of a song, the transition between one song to another song, the end of an album or the end of a series of songs, the end of a series of songs performed or written by a particular artist, the conclusion of a particular genre of music, or the transition between one genre of music to another, and the like. For example, if the musical content is pop music, then a natural stop point may be a transition between American pop music and Latin pop music.

If the media being played by the media device includes visual media, then a natural stop point may be the end of a television show, the end of a particular series or type of television show, the beginning or end of an advertisement, the end of a movie or the end of a particular chapter or scene in a movie, and the like. A natural stop point may also be the transition between different media types, such as music to television.

The multi-channel media device may also utilize information derived from the user to determine a stop point. For instance, a user may set a stop point or indicate to the media device that the user wants the media device to suspend play of content at any reasonably suitable point, such as, for example, after a particular song or after a series of songs by a particular artist. Similarly, if visual media is being played, the user may indicate to the media device that the user wants the media device to suspend play after a particular program, show, advertisement, etc.

The multi-channel media device may also monitor a user's habits and activities to determine appropriate stop points. For example, the media device may monitor the type of music the user generally listens to, including particular artists and genres. The media device may also monitor user activities, such as a user changing the channel when a particular song, artist, or genre of music is played. The user's habits and activities may be used, for instance, by machine learning algorithms to determine appropriate stop points.

Any of the above mentioned stop points or any of the methods used to determine appropriate stop points may be used alone or in any reasonably suitable combination to determine and set the stop points.

At step 204, the multi-channel media device plays content simultaneously on a first and second channel, as described above. At step 206, the multi-channel media device suspends play of the content on the first channel when the content on the first channel reaches the stop point that was determined at step 202.

Thus, the user is able to avoid listening to or watching disfavored content on a first channel, but does not miss content, which is played after the disfavored content. A user may turn back to the first channel at any time and resume playing content on the first channel from the stop point.

Turning now to FIG. 2B, there is shown a flow chart of a method 220 for operating the media device, according to a further example. The method 220 may also be implemented in conjunction with the method 100 depicted in FIG. 1 and the method 200 depicted in FIG. 2A. By way of example, the method 220 may be implemented following implementation of the method 200 to automatically suspend play of content on the second channel when the stop point has been reached during play of the content on the first channel.

At step 222, the multi-channel media device may determine that play of the content on the first channel has stopped at the determined stop point as described above. In addition, at step 224, the multi-channel media device may suspend play of the content on the second channel. Furthermore, the multi-channel media device may resume play of the content on the first channel, as indicated at step 226.

As such, for instance, a user may dislike the particular piece of media playing on the first channel, such as a song by a particular artist. To avoid listening to the disfavored song, the user may change the channel from the first channel to a second channel, while the two channels play simultaneously, as described above. However, in this example, when a stop point is reached in the content continuing to play on the first channel, the media device may suspend play of the content on the second channel and automatically resume play of the content on the first channel at the same or similar level the first channel was being played before the user changed the channel.

That is, the user may enjoy the type or genre of music being played on the first channel, but may disfavor the particular song being played. To avoid the song, the user changes to a second channel. The disfavored song may continue to play silently or at a reduced level on the first channel, while the user listens to music on the second channel. When the song on the first channel reaches a stop point, which may be the end of the song, for instance, the media device may suspend the play of content on the second channel and may automatically resume play of the content on the first channel from the end of the disfavored song. In this example, the user may avoid disfavored songs, while continuing to listen to the user's preferred channel with minimal disruption.

One or more of the steps of the methods 100, 200, and 220 described herein may be implemented as software embedded or stored on a computer readable medium, such as in the storage 306, and executed by the processor 302, which are depicted in FIG. 3. The steps may be embodied by a computer program, which may exist in a variety of forms both active and inactive. For example, they may exist as software program(s) comprised of program instructions in source code, object code, executable code or other formats for performing some of the steps when executed. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

FIG. 3 illustrates a block diagram of a multi-channel media device 300 which may be used as a hardware platform for performing the methods 100, 200, and 220, depicted in FIGS. 1, 2A, and 2B. FIG. 3 is a simplified block diagram, and the components of the multi-channel media device 300 may include many more elements not shown or some of the components may not include all the elements shown in FIG. 3.

The multi-channel media device 300 is depicted as including a processor 302, which provides a platform for executing software which provides the functionality for the multi-channel media device 300. The multi-channel media device 300 also includes a storage 306, which may include Random Access Memory (RAM) where software is resident during runtime. The storage 306 may also include one or more other types of memory such as ROM (read only memory), EPROM (erasable, programmable ROM), EEPROM (electrically erasable, programmable ROM) and data storage, such as hard disks, etc., may be used. For example, the storage 306 may include one or more hard disk drives and a removable storage drive, such as a floppy or flash memory. The storage 306 may also include software to facilitate the changing between multiple channels of the media device 300 and simultaneously playing multiple channels of the media device 300, as described in the methods 100, 200, and 220. The storage 306 may further store the cached content for playback on the media device 300.

A user may interface with the multi-channel media device 300 through an input device 310, such as, a keyboard, buttons, a mouse, a stylus, and the like. The input device 310 may provide a physical object a user may implement to select and change between different channels of the multi-channel media device 300.

The multi-channel media device 300 also includes at least one output 312. The at least one output 312 includes speakers, a headset, a display, or a combination of these devices. The speakers and/or the headset may be employed to output audio signals and the display may be employed to show video signals, including information pertaining to the content playing on one or more of the channels, such as, the current channel selection, the content(s) being played, the title(s) of the current content(s) being played, etc.

The multi-channel media device 300 further includes a network interface 314. The network interface 314 may be employed to download content from, for instance, one or more content sources over the Internet. In addition, the processor 302 may communicate with one or more of the components depicted in FIG. 3 over a bus 304.

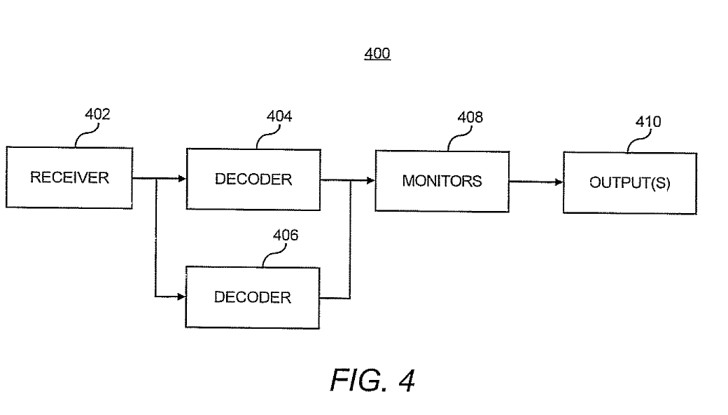

Turning now to FIG. 4, there is shown a logical flow diagram 400 of a processor 302 configured perform various functions of the multi-channel media device 300, according to an embodiment of the invention. More particularly, the logical flow diagram 400 depicts an example of some of the components the processor 302 may contain to generally enable the multi-channel media device 300 to simultaneously play content on multiple channels.

As shown in FIG. 4, the processor 302 includes a receiver 402 for receiving content from a content source in any of the manners as described herein above. The receiver 402 may operate to receive content through any reasonably suitable known medium, such as, through a wired or wireless connection to a network. In one example, the receiver 402 may enable a wired or a wireless connection to the Internet.

The processor 302 also includes a plurality of decoders 404, 406 configured to decode the content received through the receiver 402 in the multiple channels. In addition, the processor 302 includes monitors 408 configured to monitor one or more aspects of the content and/or the channels. For instance, the monitors 408 may be employed to monitor the play time of each channel, the rules or constraints associated with content being played or stored in the multi-channel media device 300, whether one or more stop points have been reached, etc. The one or more aspects of the content and/or the channels may be contained as metadata of the content.

In one example, therefore, the one or more stop points may be stored in the metadata of the content. In addition, or alternatively, the one or more stop points may be flagged such that the one or more stop points may be readily detected by the monitors 408.

The processor 302 may also cause the content received through the receiver 402 to be played through one or more outputs 410. The one or more outputs 410 may comprise the at least one output 312 described above. In addition, processor 302 may communicate with the storage 306 to play the content stored therein.

Through implementation of the systems and methods described above, a user may avoid listening to and/or viewing disfavored content by changing to another channel while the undesirable content continues to play in the background. When the user does return to the channel, for instance, after the undesirable content has finished playing in the background, the user starts with new content. As such, the systems and methods described above provide users with greater control of their media experience by allowing them to switch to other content channels while content continues to play in the previously selected channel(s). In one regard, therefore, a user may use a multi-channel media device in manners that substantially mimic the behavior of standard broadcast radio devices.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method for playing content on a multi-channel media device, said method comprising the steps of:
receiving content on at least one channel of the multi-channel media device;
playing the content on a first channel of the multi-channel media device, wherein the content comprises one of cached and streamed content;
detecting a first user-interaction with the multi-channel media device; and
playing content on a second channel of the multi-channel media device in response to the detected first user-interaction, while simultaneously playing the content on the first channel.

2. The method of claim 1, wherein playing content on a second channel of the multi-channel media device in response to the detected first user-interaction further comprises playing the content on the first channel at a reduced level.

3. The method of claim 2, wherein the reduced level is selected from one of a level not perceived by the user and a level less prominently perceived by the user.

4. The method of claim 1, further comprising:
disabling the ability to play content on a second channel while simultaneously playing the content on the first channel for at least part of the content.

5. The method of claim 1, wherein detecting a first user-interaction comprises detecting a change in the channel of the multi-channel media device.

6. The method of claim 1, further comprising:
suspending play of the content on the first channel when a stop point in the content playing on the first channel is reached.

7. The method of claim 6, further comprising:
resuming play of the content on the first channel from the stop point in the content when a second user-interaction with the multi-channel media device is detected.

8. The method of claim 1, wherein receiving content and playing the content further comprise receiving and playing content that is subject to at least one constraint that limits manners in which the content is at least one of received and played.

9. The method of claim 1, further comprising:
suspending play of the content on the second channel when a stop point in the content playing on the first channel is reached.

10. The method of claim 1, further comprising:
utilizing the first user-interaction to determine a user's preferences for the content being played on the first channel.

11. The method of claim 1, further comprising:
utilizing the first user-interaction to determine the stop point in the content.

12. A multi-channel media device for simultaneously playing content on multiple channels, said device comprising:
software configured to decode a first content playable on a first channel of the multi-channel media device, wherein the content comprises at least one of cached and streamed content;
software configured to decode a second content playable on a second channel of the multi-channel media device;
a processor configured to implement software for simultaneously playing the decoded second content on the second channel while playing the decoded first content on the first channel.

13. The multi-channel media device of claim 12, further comprising:
a monitor configured to monitor the play of the first content; and
wherein the processor is configured to implement software for suspending play of the first content playing on the first channel when a stop point in the first content is detected by the monitor.

14. The multi-channel media device of claim 13, wherein the processor is configured to implement software for resuming play of the first content on the first channel from the stop point when a user-interaction with the multi-channel media device is detected.

15. The multi-channel media device of claim 12, further comprising:
a monitor configured to monitor the play of the second content; and
wherein the processor is configured to implement software for suspending play of the second content playing on the second channel when a stop point in the content playing on the first channel is detected by the monitor.

16. The multi-channel media device of claim 12, wherein the processor is configured to implement software for playing the first content on the first channel at a reduced output level after a first user-interaction is detected, and wherein the processor is further configured to implement software for causing the second content on the second channel to be played in response to the first user-interaction being detected.

17. The multi-channel media device of claim 12, further comprising:
a plurality of outputs; and
wherein the processor is configured to implement software for causing the first content to be played through a first output of the plurality of outputs and for causing the second content to be played through a second output of the plurality of outputs.

18. The multi-channel media device of claim 12, wherein the processor is configured to implement software for utilizing the first user-interaction to determine the stop point in the content.

19. The multi-channel media device of claim 12, wherein the device comprises at least one of a personal computer, a personal digital assistant, a telephone, a radio, a stereo, a set top box, an MP3 player, and a video player.

20. A computer readable medium upon which is stored a computer program, said computer program implementing a method for playing content on a multi-channel media device when executed by a processor, said computer program comprising a set of instructions to:
receive content on at least one channel of a multi-channel media device;
play the content on a first channel of the multi-channel media device, wherein the content comprises one of cached and streamed content;
detect a first user-interaction with the multi-channel media device; and
play content on a second channel of the multi-channel media device in response to the first user-interaction being detected, while simultaneously playing the content on the first channel.

21. The computer readable medium according to claim 20, wherein playing content on a second channel of the multi-channel media device in response to the detected first user-interaction further comprises playing the content on the first channel at a reduced output level.

22. The computer readable medium according to claim 20, wherein playing content on a second channel of the multi-channel media device in response to the detected first user-interaction further comprises playing the content on the first channel on a first output device and playing the content on the second channel on a second output device, wherein the first output device differs from the second output device.

23. The computer readable medium according to claim 20, said computer program comprising a further set of instructions to:
disable the ability to play content on a second channel while simultaneously playing the content on the first channel for at least part of the content.

24. The computer readable medium according to claim 20, said computer program comprising a further set of instructions to:
suspend play of the content on the first channel when a stop point in the content playing on the first channel is reached; and
resume play of the content on the first channel from the stop point in the content when a second user-interaction with the multi-channel media device is detected.

25. The computer readable medium according to claim 20, said computer program comprising a further set of instructions to:
receive and play content that is subject to at least one constraint that limits manners in which the content is at least one of received and played.
